(19) United States
(12) Patent Application Publication
(10) Pub. No.: US 2026/0149341 A1
(43) Pub. Date: May 28, 2026

(54) ROTOR ASSEMBLIES WITH FLEXIBLE SHAFT INTERFACES

(71) Applicant: DANA TM4 INC., Boucherville (CA)

(72) Inventors: Rafaël BÉDARD, Otterburn Park (CA); Benoit BLANCHARD ST-JACQUES, Boucherville (CA)

(21) Appl. No.: 19/391,941

(22) Filed: Nov. 17, 2025

Related U.S. Application Data
(60) Provisional application No. 63/725,723, filed on Nov. 27, 2024.

(51) Int. Cl. H02K 11/30; H02K 7/00

(52) U.S. Cl. CPC H02K 11/30; H02K 7/003

(57) ABSTRACT

Systems and methods are provided for a rotor assembly including a rotor shaft and a press-fit rotor core positioned on the rotor shaft. The rotor core includes circumferential cavities positioned proximate to the rotor shaft. The cavities are arranged in one or more rings concentric with each other and with the rotor shaft, and the cavities are filled with an elastic material.

### CROSS REFERENCE TO RELATED APPLICATION

The present application claims priority to U.S. Provisional Application No. 63/725,723 entitled ROTOR ASSEMBLIES WITH FLEXIBLE SHAFT INTERFACES filed Nov. 27, 2024. The entire content of the above application is hereby incorporated by reference for all purposes.

### TECHNICAL FIELD

The present description relates generally to rotor assemblies with flexible shaft interfaces where a press-fit rotor core is positioned on a rotor shaft.

### BACKGROUND AND SUMMARY

In electric motors, a rotor core may be rotationally coupled with a rotor shaft by press-fitting (e.g., interference fitting) the rotor core onto the rotor shaft. Strong centrifugal forces experienced during rotation of the rotor shaft and rotor core at high rotational speeds may diminish strength of contact pressure induced by the press fit, reducing strength of the mechanical coupling or completely decoupling the rotor shaft from the rotor core. Degradation of the rotational coupling between the rotor shaft and the rotor core may impede performance of the electric motor, for example by causing increased torque transfer losses, increased thermal resistance, and increased vibration. Increasing interference between the rotor shaft and the rotor core may reduce a likelihood of degradation to the rotational and mechanical coupling between the rotor core and the rotor shaft. However, stress on the components is intensified with greater interference, and assembly may be more challenging. Excessive stress, particularly at a pole section of the rotor core where magnets or windings are located, may cause perturbation of the magnetic field and increase in noise, vibration, and harshness (NVH) levels of the electric motor.

Thus, embodiments of rotor assemblies that address at least some of the issues described above are disclosed herein. For example, a rotor assembly in accordance with the present disclosure comprises a rotor shaft; and a press-fit rotor core positioned on the rotor shaft. The rotor core includes circumferential cavities positioned proximate to the rotor shaft, where the cavities are arranged in one or more rings concentric with each other and with the rotor shaft. The cavities may be filled with an elastic material.

In this way, flexibility is introduced at the interface between the rotor shaft and the rotor core by embedding the cavities that are filled with elastic material therein, increasing compliance and reducing stresses generated by high interference fit. Such flexibility may allow for higher deflections, strengthening the resistance to centrifugal separation without increasing overall stress. Additionally, the stress field may be localized in the flexible areas, decreasing stress generation radially further from the rotor shaft than the cavities filled with the elastic material. Specifically, stress at or near the pole section of the rotor core may be at least partially mitigated. In this way, buckling of the rotor core, which causes perturbation of the magnetic field and negatively affects NVH performance of the electric motor, may be prevented. The elastic-filled cavities may maintain sufficient contact pressure to transfer torque between the rotor shaft and the rotor core, and also to sustain external loads, for example from roads for automotive applications.

The elastic-filled cavities may be dimensioned and optimized for different applications. For example, flexible contact areas between the rotor shaft and the rotor core may be continuous or include a plurality of local contacts, according to metrics of an application such as contact pressure of press-fit, rotational speed range of the electric motor, size of the rotor core, etc. As another example, rigid contact areas may be included in addition to flexible contact areas to mitigate dynamic imbalance at high rotational speeds due to excess deflection under high centrifugal forces. Further, the elastic material may also be thermally conductive to reduce thermal resistance between the rotor core and the rotor shaft introduced by the cavities, for example in applications where the rotor core is cooled via coolant fluid flowing through the rotor shaft.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows an electric motor, including a rotor assembly comprising a rotor core and a rotor shaft in accordance with the present disclosure.

FIG. 2 shows a schematic of a cross section of the electric motor of FIG. 1.

FIG. 3 shows an example of the rotor assembly of FIG. 1.

FIG. 4 shows a zoomed in view of dashed circumferential cavities of the example of the rotor assembly of FIG. 3.

FIG. 5 shows an example of the rotor assembly of FIG. 1.

FIG. 6 shows a zoomed in view of dashed circumferential cavities of the example of the rotor assembly of FIG. 5.

FIG. 7 shows an example of the rotor assembly of FIG. 1.

FIG. 8 shows a zoomed in view of dashed circumferential cavities of the example of the rotor assembly of FIG. 7.

FIG. 9 shows an example of the rotor assembly of FIG. 1 with continuous flexible contact between the rotor core and the rotor shaft.

FIG. 10 shows an example of the rotor assembly of FIG. 1 with discontinuous flexible contact between the rotor core and the rotor shaft.

FIG. 11 shows an example of the rotor assembly of FIG. 1 with alternating discontinuous rigid and discontinuous flexible contact between the rotor core and the rotor shaft.

FIG. 12 shows a flowchart of a method for constructing a rotor assembly in accordance with the present disclosure, such as the examples in FIGS. 3-11.

FIG. 13 shows schematics of parts of the rotor assembly at different points of the method of FIG. 12.

### DETAILED DESCRIPTION

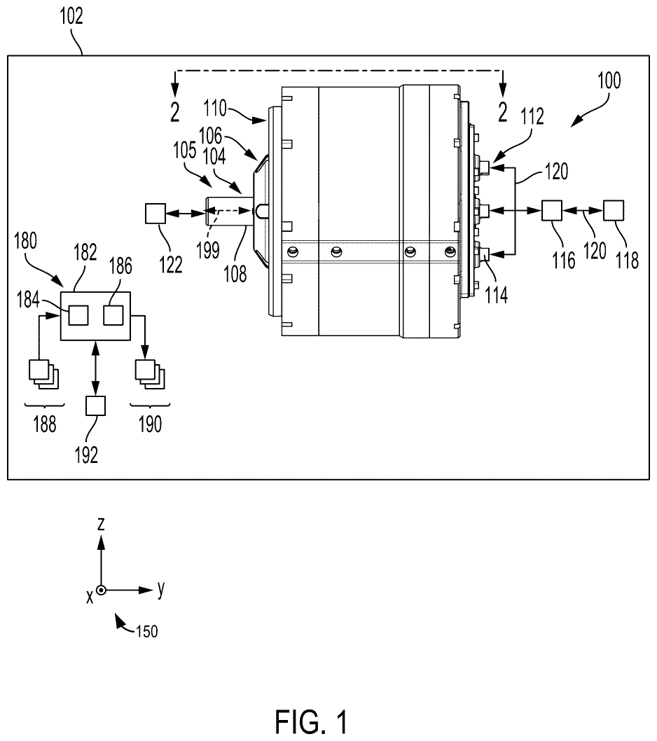

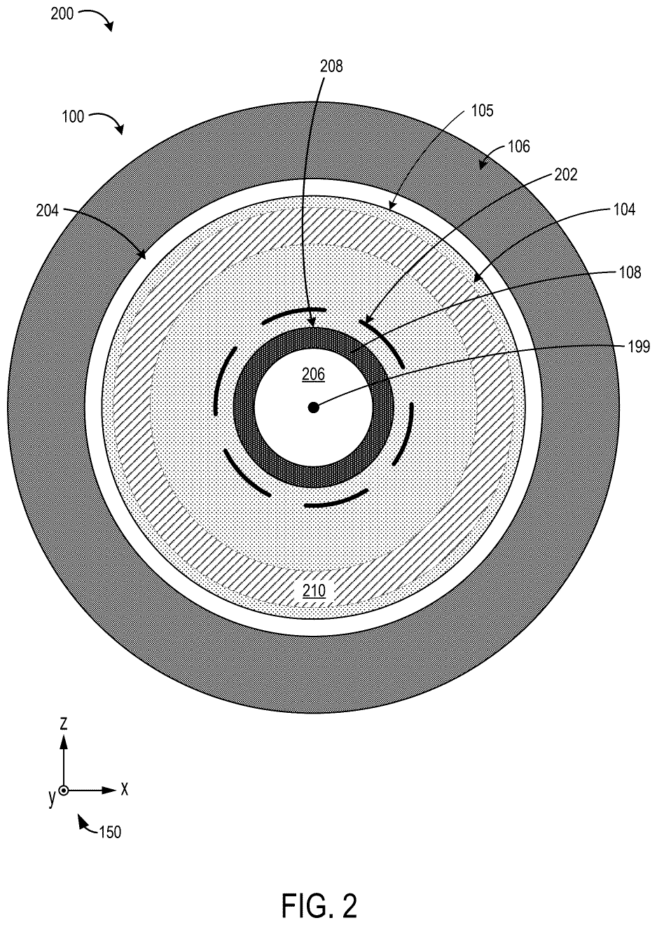

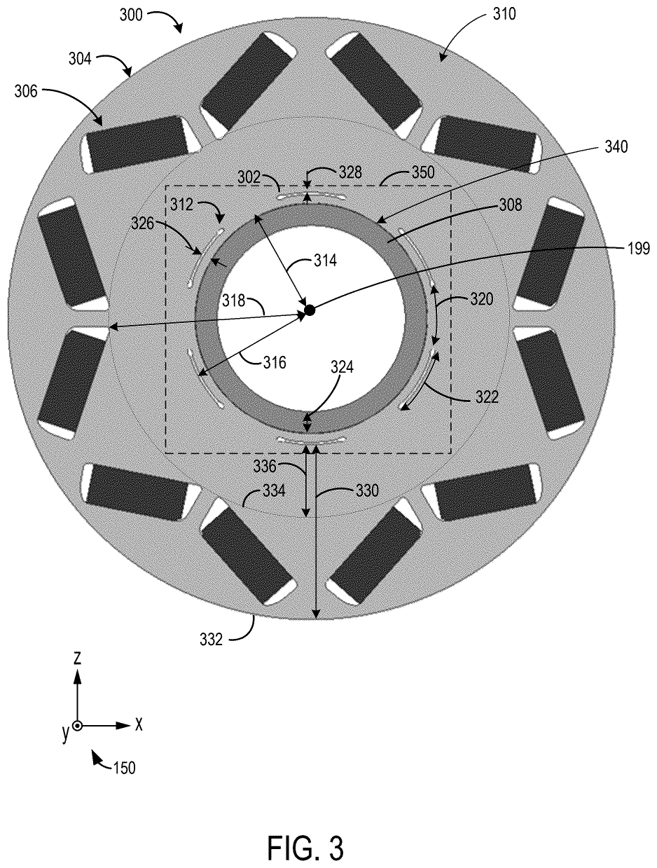

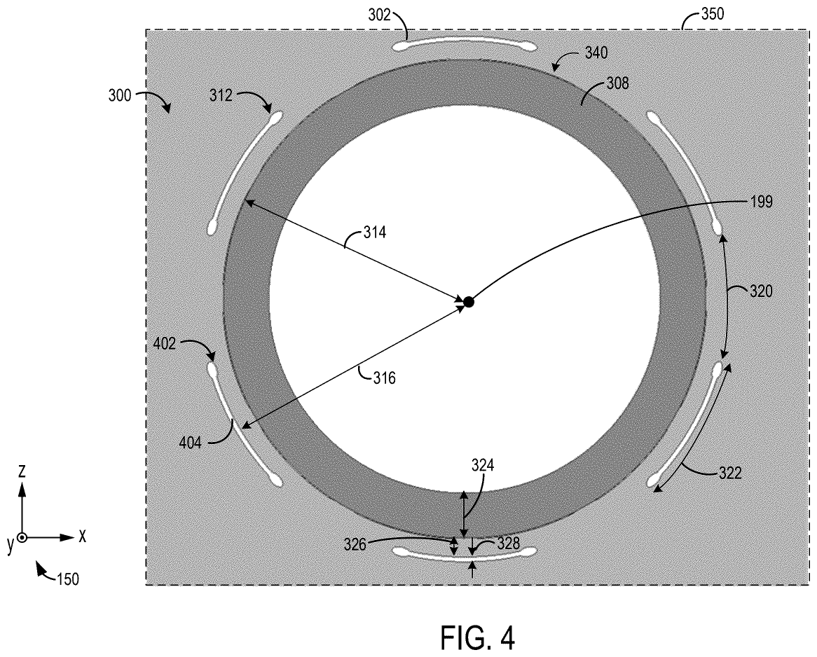

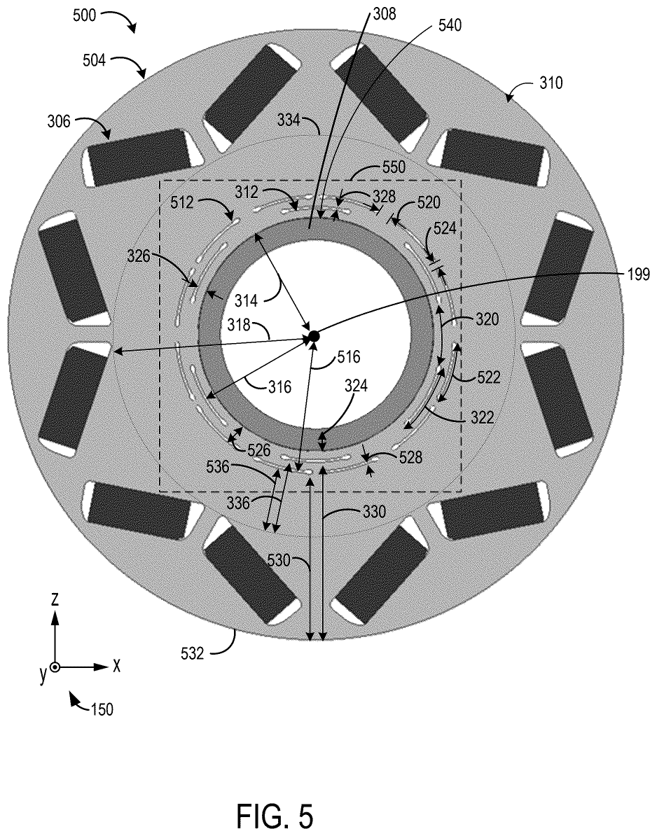

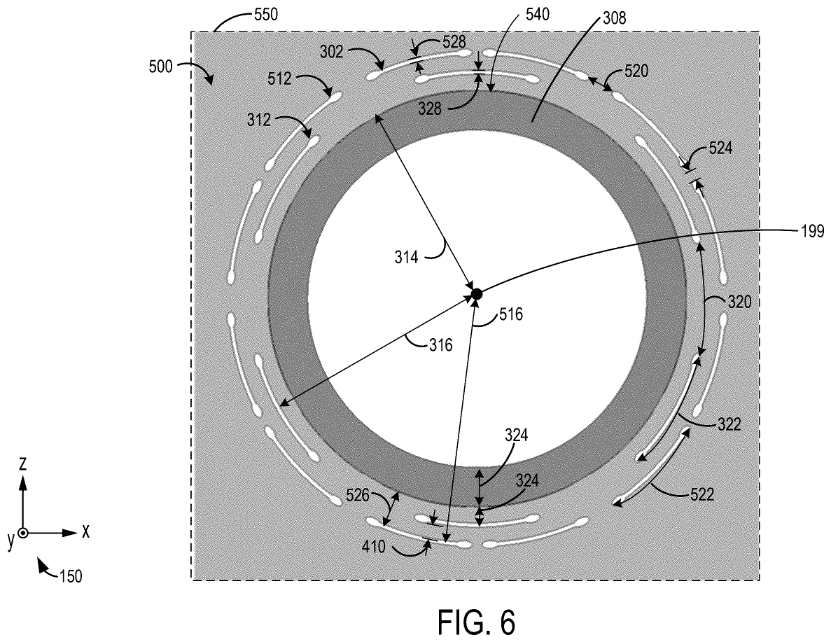

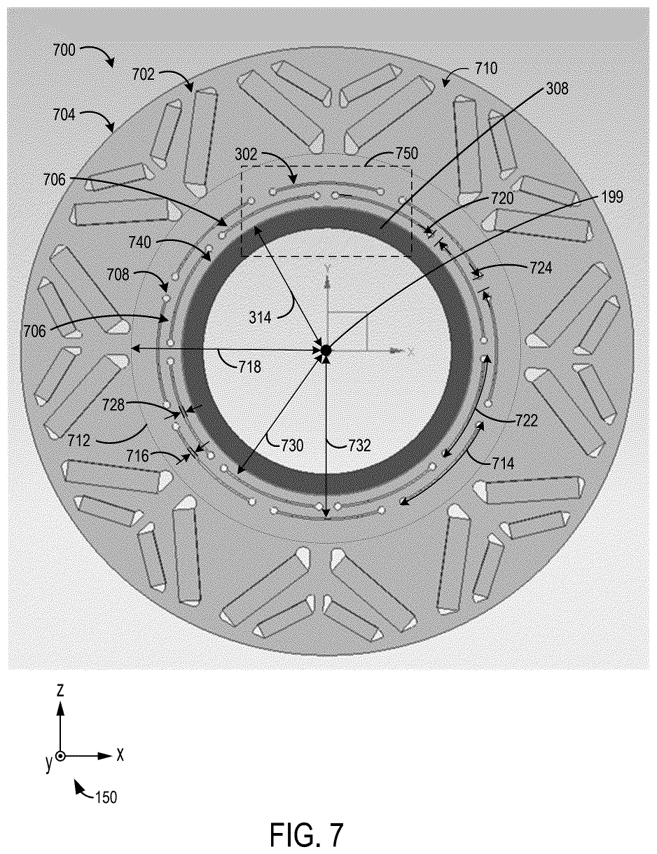

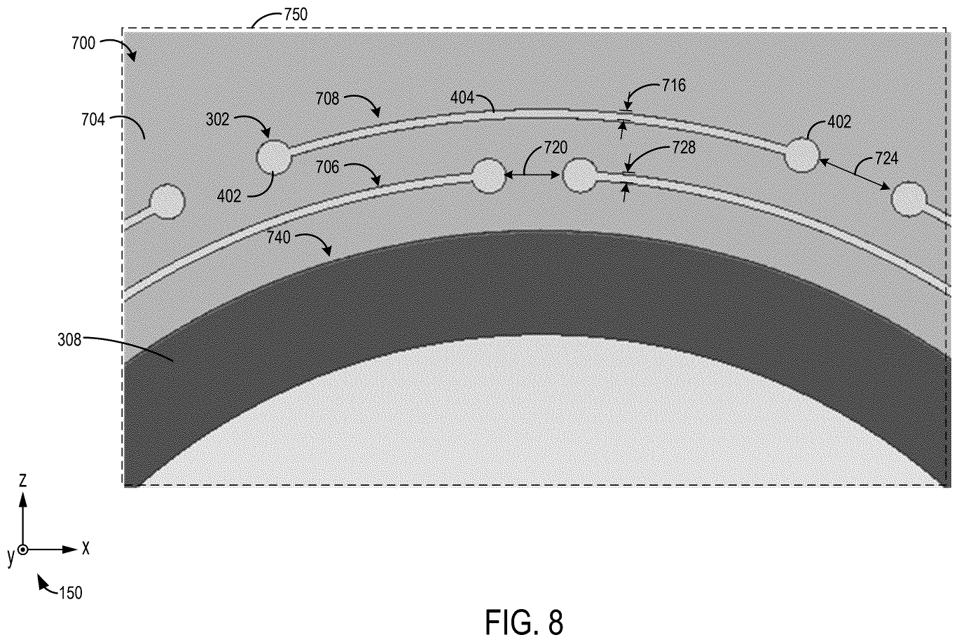

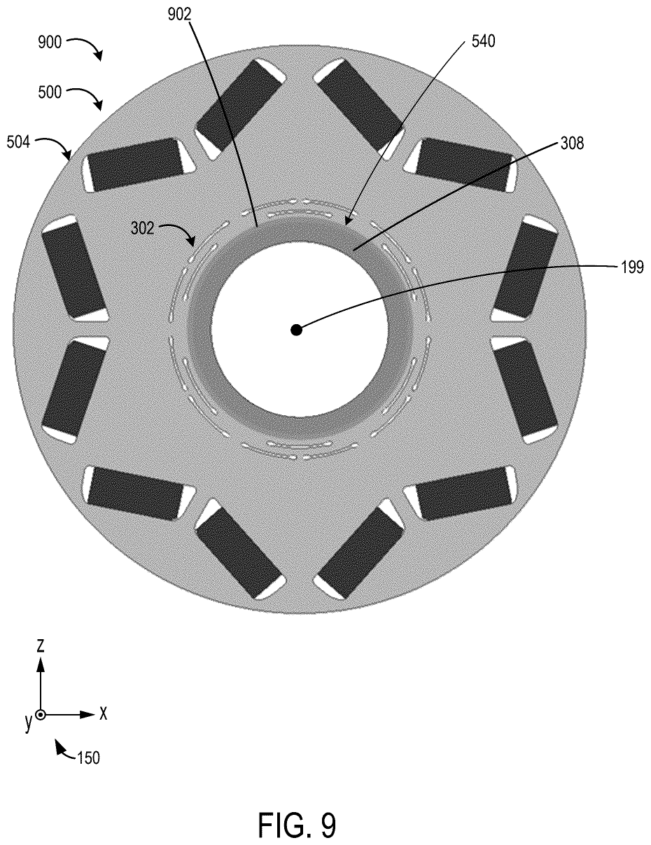

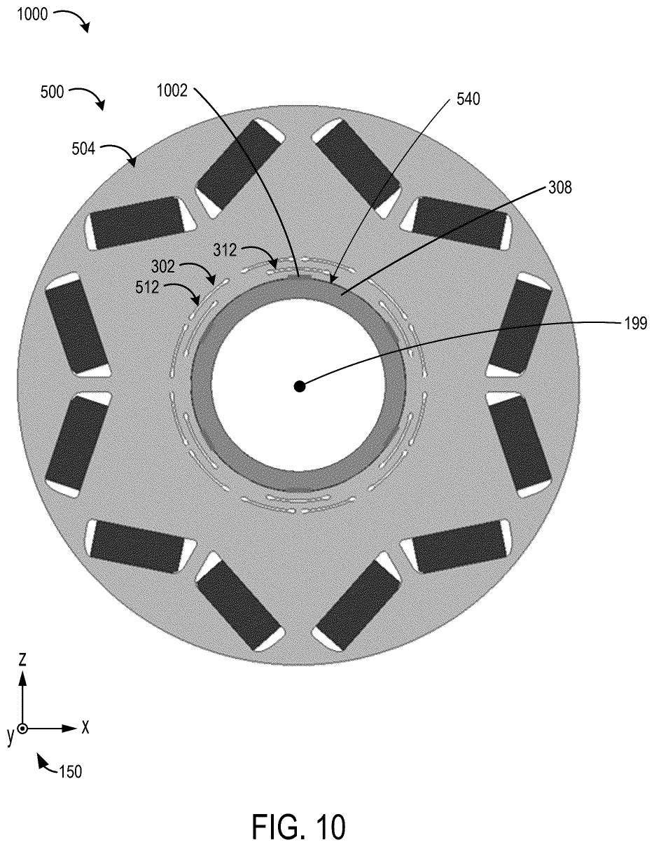

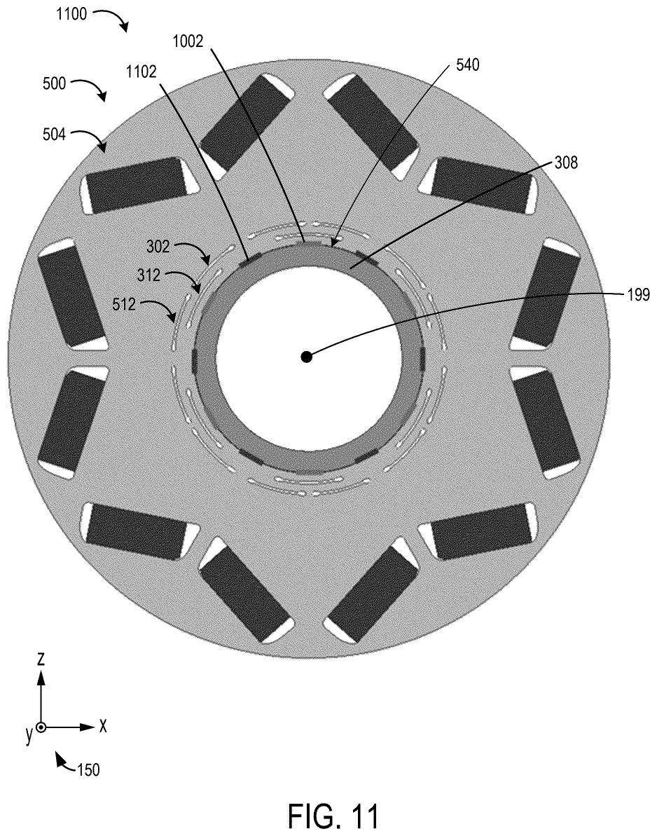

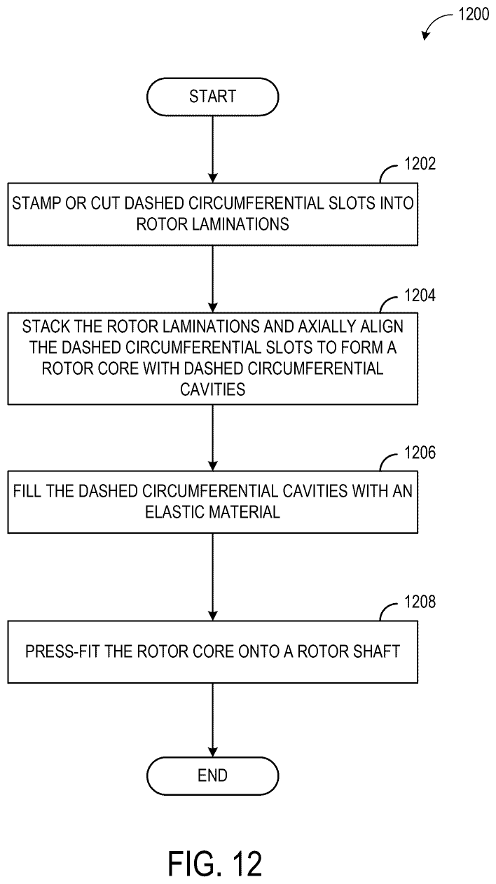

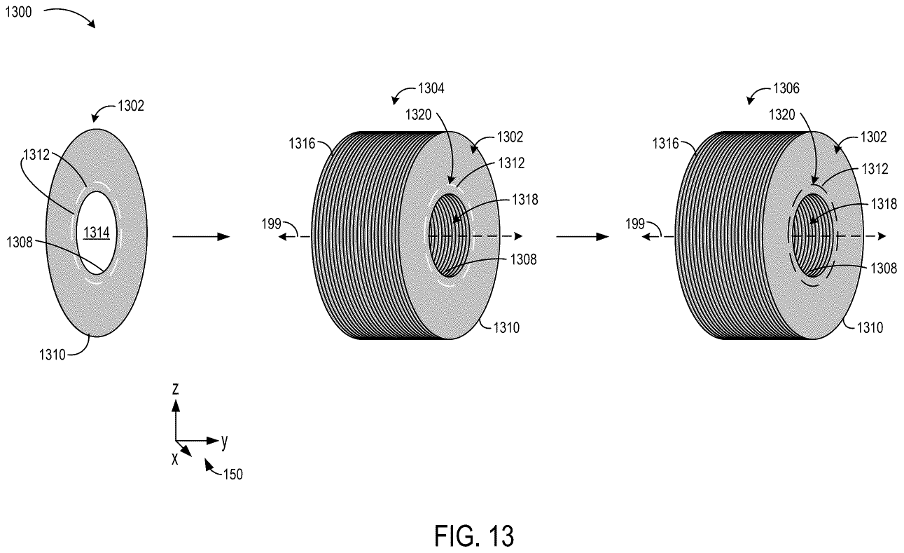

The following description relates to systems and methods for rotor assemblies of electric motors, where the rotor assemblies include a rotor shaft and a rotor core press-fit thereon with a flexible interface therebetween. FIG. 1 shows an exemplary electric motor, including a stator and a rotor assembly in accordance with the present disclosure. The electric motor may be incorporated into a vehicle such as an electric or hybrid vehicle, or other machinery demanding energy conversion between electrical and mechanical forms. A cross section of the electric motor is shown schematically in FIG. 2. The rotor core of the rotor assembly may include dashed circumferential cavities positioned proximate to the rotor shaft and filled with an elastic material such that when the rotor core is press-fitted onto the rotor shaft, an interface between the rotor core and the rotor shaft is flexible. Flexibility of the interface may concentrate stress in the elastic material, allowing for increased interference, and therefore increased strength of the mechanical and rotational coupling between the rotor core and the rotor shaft, without increasing stress at a pole section of the rotor core. The dashed circumferential cavities that are filled with the elastic material may be arranged in one or more rings that are concentric with each other and with the rotor shaft. A first example of the rotor assembly with a single ring of dashed circumferential cavities is shown in FIGS. 3 and 4. A second example of the rotor assembly with two rings of dashed circumferential cavities is shown in FIGS. 5 and 6. A third example of the rotor assembly with two rings of dashed circumferential cavities is shown in FIGS. 7 and 8. In addition to the number and arrangement of the dashed circumferential cavities, the contact conditions at the interface may be adjusted between examples according to an application of the electric motor (e.g., size, weight, maximum rotational speed, etc.). Contact conditions may include continuous flexible as shown in FIG. 9, discontinuous flexible as shown in FIG. 10, and alternating discontinuous rigid and discontinuous flexible as shown in FIG. 11. A method for forming a rotor assembly in accordance with the present disclosure is provided as a flowchart in FIG. 12. Some steps of the method of FIG. 12 are shown schematically in FIG. 13.

It is to be understood that the specific assemblies and systems illustrated in the attached drawings, and described in the following specification are exemplary embodiments of the inventive concepts defined herein. For purposes of discussion, the drawings are described collectively. Thus, like elements may be commonly referred to herein with like reference numerals and may not be re-introduced.

Turning to FIG. 1, an illustration of an electric motor 100 is shown. Reference axes 150 are provided in FIG. 1, as well as FIGS. 2-11 and 13. The z-axis may be a vertical axis (e.g., parallel to a gravitational axis), the x-axis may be a lateral axis (e.g., horizontal axis), and/or the y-axis may be a longitudinal axis, in one example. Additionally or alternatively, the y-axis may be parallel to an axial direction, while the z-axis and x-axis may be parallel to radial directions. However, the axes may have other orientations, in other examples. Rotational axis 199 is shown in FIG. 1, as well as FIGS. 2-11. A cutting plane 2-2 for the cross-sectional view depicted in FIG. 2 is provided in FIG. 1. The cutting plane 2-2 extends through the rotational axis 199 of the motor 100.

The electric motor 100 may be designed as an electric motor-generator and may be included in a system 102 which may take a variety forms. For instance, the electric motor 100 may be incorporated into an electric drive system of an electric vehicle (EV), in one example. As such, the electric motor 100 is a traction motor in such an example and the electric drive may further include a transmission (e.g., gearbox), for instance. In the EV example, the EV may be an all-electric vehicle (e.g., a battery electric vehicle (BEV)), in one example, or a hybrid electric vehicle (HEV) with an internal combustion engine, in another example. However, the electric motor 100 may be used in other suitable systems (e.g., stationary systems), in other examples, such as in industrial machines, agricultural systems, mining systems, and the like.

The electric motor 100 includes a rotor core 104 that electromagnetically interacts with a stator 106 to drive rotation of a rotor shaft 108. The rotor core 104 may be circumferentially surrounded by the stator 106. The rotor core 104 and the rotor shaft 108 are mechanically and rotationally coupled via press-fit (e.g., interference fit) to form a rotor assembly 105. The press-fit interface between the rotor core 104 and the rotor shaft 108 may be flexible due to dashed circumferential cavities in the rotor core 104 that are proximate to the rotor shaft 108 and filled with an elastic material, as described further below. The flexibility of the interface between the rotor core 104 and the rotor shaft 108 may allow for greater interference with reduced stress, particularly at a pole section of the rotor core, providing a more secure mechanical and rotational coupling therebetween and lessening consequences of excess stress at the pole section including buckling of the rotor core 104, perturbation of the magnetic field produced by the rotor core 104, and increased noise vibration and harshness (NVH) levels.

The electric motor 100 in the illustrated example includes a housing 110 with an electrical interface 112 for the stator 106. The electrical interface 112 may be a multi-phase electrical interface with multiple electrical connectors 114. The electrical interface 112 is a three-phase interface, in the illustrated example. However, it will be understood that the electrical interface may be a six phase interface or a nine phase interface, in other examples. More generally, the electric motor 100 may be a multi-phase alternating current (AC) machine. However, in other examples, the electric motor 100 may be a direct current (DC) machine.

As illustrated in FIG. 1, the electric motor 100 may be electrically coupled to an inverter 116. The inverter 116 is designed to convert direct current (DC) power to alternating current (AC) power and vice versa. As such, the electric motor 100 may be an AC electric motor, as indicated above. However, in other examples, the electric motor 100 may be a DC electric motor (as previously indicated) and the inverter 116 may therefore be omitted from the system 102. The inverter 116 may receive electric energy from one or more energy storage device(s) 118 (e.g., traction batteries, capacitors, combinations thereof, and the like). Arrows 120 signify the electric energy transfer between the electric motor 100, the inverter 116, and the energy storage device(s) 118 that may occur during different modes of system operation.

The system 102 may additionally include a control sub-system 180 with a controller 182. The controller 182 includes a processor 184 and memory 186. The memory 186 may hold instructions stored therein that when executed by the processor 184 cause the controller 182 to perform the various methods, control techniques, and the like, described herein. The processor 184 may include a microprocessor unit and/or other types of circuits. The memory 186 may include known data storage mediums such as random access memory, read-only memory, keep alive memory, combinations thereof, and the like.

The controller 182 may receive various signals from sensors 188 positioned in different locations in the system 102. The sensors 188 may include an electric machine speed sensor, energy storage device temperature sensor(s), an energy storage device state of charge sensor(s), an inverter power sensor, and the like. The controller 182 may also send control signals to various actuators 190 coupled at different locations in the system 102. For instance, the controller may send signals to the inverter 116 to adjust the rotational speed of the electric motor 100 (e.g., rotational speed of the rotor assembly 105). In another example, the controller 182 may send a command signal to the electric motor 100 and/or the inverter 116 and in response, motor speed may be adjusted. The other controllable components in the system 102 may function in a similar manner with regard to command signals and actuator adjustment.

The system 102 may also include one or more input device(s) 192 (e.g., an accelerator pedal, a brake pedal, a console instrument panel, a touch interface, a touch panel, a keyboard, combinations thereof, and the like). The input device(s) 192 may generate a motor speed adjustment request responsive to user input.

In at least some examples, the system 102 may also include a thermal management system 122 configured to cool the rotor assembly 105 and/or the stator 106. For example, the thermal management system 122 may deliver coolant fluid (e.g., oil) to the electric motor 100 where the coolant fluid may flow through the rotor shaft 108 in order to cool the rotor assembly 105. In such examples, the elastic material that fills the cavities of the rotor core 104 may be thermally conductive, as described further below.

Turning to FIG. 2, a cross section view 200 is schematically shown of the electric motor 100. As described above, the electric motor 100 includes the stator 106, the rotor core 104, and the rotor shaft 108. The rotational axis 199 is perpendicular with the page and represented with a dot in FIGS. 2-11.

The stator 106 circumferentially surrounds the rotor core 104, and the rotor core 104 circumferentially surrounds the rotor shaft 108. The stator 106, the rotor core 104, and the rotor shaft 108 are concentrically positioned relative to one another and centered on the rotational axis 199. There may be a circumferential gap 204 between the stator 106 and the rotor core 104. The stator 106 may remain stationary while the rotor assembly 105 (e.g., the rotor core 104 and the rotor shaft 108) rotates about the rotational axis 199.

The rotor core 104 may include a pole section 210 (e.g., region shaded with diagonal lines), where electromagnetic elements (e.g., electromagnetic elements 306 of FIGS. 3, 5, and 9-11) such as permanent magnets or windings are positioned. The electromagnetic elements interact electromagnetically with electromagnetic elements of the stator 106 to drive rotation of the rotor assembly 105.

The rotor core 104 may further include dashed circumferential cavities 202 that are filled with an elastic material, such as a rubber material. In this way, the elastic material may be embedded within the rotor core 104. In some examples, the elastic material may be thermally conductive. In other examples, the cavities may additionally be filled with a second material that is a thermally conductive material, where for example, the second material and the elastic material are mixed during or prior to filling the cavities 202 therewith. The dashed circumferential cavities 202 may be spaced away from the pole section 210. Specifically, the dashed circumferential cavities 202 may be in closer proximity to the rotor shaft 108 than the pole section 210. Therefore, the pole section 210 may be radially closer to the stator 106 than the dashed circumferential cavities 202. The dashed circumferential cavities 202 may be concentric with the pole section 210 and the rotor shaft 108. The dashed circumferential cavities 202 may be uniformly distributed around the rotational axis 199, providing rotational symmetry to the rotor core 104. For example, each cavity of the dashed circumferential cavities 202 may be approximately the same shape and size and equidistantly positioned with respect to adjacent cavities. In some examples, there may be a single ring of dashed circumferential cavities 202. In other examples, the dashed circumferential cavities 202 may be arranged in two or more rings concentric with each other and with the shaft, as described further below. There may be three or more cavities per ring of dashed circumferential cavities 202.

The rotor core 104 may be laminated such that the rotor core 104 comprises a plurality of rotor laminations in x-z planes. The rotor laminations may be stacked along the rotational axis 199 and axially aligned. For example, the rotor laminations may be axially aligned such that dashed circumferential slots in each of the rotor laminations are axially aligned to form the dashed circumferential cavities 202.

The rotor shaft 108 may be hollow in at least some examples. In this way, the rotor shaft 108 may encompass a hollow center 206. The hollow center 206 may reduce weight of the rotor shaft 108 and allow coolant fluid (e.g., coolant fluid delivered by the thermal management system 122 of FIG. 1) to flow therethrough in order to reduce a temperature of the rotor assembly 105, specifically the pole section 210 where heat is accumulated during operation of the electric machine. In such examples where the rotor assembly 105 is cooled via coolant fluid in the hollow center 206, the cavities 202 may be filled with a thermally conductive material (e.g., an elastic and thermally conductive material or a blend of an elastic material and a thermally conductive material) so as to prevent the cavities 202 from interfering with heat transfer between the rotor shaft 108 and the pole section 210.

The rotor core 104 may be positioned on the rotor shaft 108. The rotor core 104 may be press-fitted onto the rotor shaft 108. Thus, the rotor shaft 108 may be mechanically and rotationally coupled to the rotor core 104 via interference. For example, the rotor shaft 108 may be constructed with a larger outer diameter than an inner diameter of the rotor core 104, and the rotor shaft 108 may be forced into the rotor core 104, resulting in an interference fit. An interface 208 is formed between the rotor core 104 and the rotor shaft 108 where the rotor core 104 and the rotor shaft 108 are in face sharing contact and mechanically coupled via contact pressure at the interface 208. There may be different contact conditions at the interface 208, as described further with regard to FIGS. 9-11.

The larger the difference between the outer diameter of the rotor shaft 108 and the inner diameter of the rotor core 104, the greater the contact pressure therebetween. Increasing contact pressure may increase resistance to rotational separation of the rotor core 104 and the rotor shaft 108 under high centrifugal forces (e.g., at high rotational speeds of the rotor assembly 105). In conventional rotor assemblies (e.g., without elastic-filled cavities), greater contact pressure may also increase stress throughout the rotor assembly 105, including the pole section 210. However, in rotor assembly 105 of the present disclosure, the dashed circumferential cavities 202 being filled with an elastic material may concentrate stress therein and make the interface 208 more flexible, allowing for increased interference without increasing stress in other regions of the rotor core 104, such as the pole section 210. In this way, a strength of the mechanical and rotational coupling between the rotor core 104 and the rotor shaft 108 may be enhanced. Therefore, the rotor assembly 105 may be able to rotate at higher rotational speeds than conventional rotor assemblies without decoupling the rotor core 104 and the rotor shaft 108. Additionally, greater stress resulting from the higher rotational speeds may be passively directed away from the pole section 210 and into the dashed circumferential cavities 202, reducing perturbation of the electromagnetic field and NVH levels.

Alternatively, dashed circumferential cavities may be formed into the rotor shaft 108 and filled with an elastic material to increase flexibility of the interface 208. However, by having elastic material embedded in the rotor core 104, rather than the rotor shaft 108, manufacturing may be simpler. For example, because rotor laminations are already stamped or cut (e.g., laser cut or electrical discharge machining (EDM) cut) in conventional manufacturing processes, forming the dashed circumferential slots may not add additional manufacturing steps. Additionally, there may be fewer structural constraints in forming the dashed circumferential cavities 202 in the rotor core 104 compared to the rotor shaft 108. A method for forming a rotor assembly in accordance with the present disclosure is described further in regard to FIGS. 12 and 13.

The dashed circumferential cavities 202 may be arranged in various configurations in the rotor core 104 to provide flexibility of the interface 208 and at least some of the associated advantages described above. Examples of rotor assemblies in accordance with the present disclosure including various dashed circumferential cavity configurations are described further in regards to FIGS. 3-11.

Turning to FIGS. 3 and 4, a first example of a rotor assembly 300 in accordance with the present disclosure is shown in an axial view looking down the rotational axis 199. The rotor assembly 300 is an example of the rotor assembly 105 of FIGS. 1 and 2. As such, the rotor assembly 300 includes a press-fit rotor core 304 (e.g., a first example of the rotor core 104) positioned on a rotor shaft 308 (e.g., a first example of the rotor shaft 108) with a flexible interface 340 (e.g., a first example of the interface 208) therebetween. A portion 350 of FIG. 3 is shown enlarged for detail in FIG. 4.

The rotor core 304 may include electromagnetic elements 306. In some examples, the electromagnetic elements 306 may include magnets embedded in the rotor core 304. Additionally or alternatively, electromagnetic elements 306 may include windings (e.g., electrically conductive wires) extending through or around the rotor core 304. The electromagnetic elements 306 may electromagnetically interact with a stator to induce rotation of the rotor assembly 300 about the rotational axis 199. A pole section 310 may be a region of the rotor core 304 where the electromagnetic elements 306 are located.

The rotor core 304 further includes a ring 312 of cavities 302. The cavities 302 may be dashed, or discontinuous, along the ring 312 with spaces between the cavities 302. The ring 312 of cavities 302 may be concentric with the rotor shaft 308 about the rotational axis 199. The cavities 302 may be shaped and sized approximately the same to one another. The cavities 302 may arc (e.g., curve, bend, etc.) to follow a circular path around the rotor shaft 308. The cavities 302 may each have a length 322 (e.g., arc length) and a width 328 (e.g., radial dimension), where the length 322 is larger than the width 328 such that the cavities 302 are elongated in the angular directions. The cavities 302 may be uniformly distributed with an equidistant spacing of angular distance 320 between adjacent cavities 302. In this way, the presence of the cavities 302 may not impede rotational balance of the rotor core 304.

As described above, the cavities 302 may be filled with an elastic material to provide flexibility to the flexible interface 340 between the rotor core 304 and the rotor shaft 308. The angular distance 320 may be greater than, approximately equal to, or less than the length 322 of the cavities 302, according to a desired proportion of flexible areas along the ring 312. In comparing two examples with the same number of cavities 302 in the ring 312, the example with a greater distance 320 (and therefore shorter length 322) may have relatively less flexibility in the interface 340.

Alternatively, the cavities 302 may not all be the same size. For example, length 322 of some cavities 302 may be longer than others. In such an example, each set of the cavities 302 of the same size and shape may be evenly distributed with regard to the rotational axis 199. For example, longer cavities may be alternated with shorter cavities to maintain rotational balance of the rotor assembly 300.

The cavities 302 may be a first radial distance 326 from the rotor shaft 308. The first radial distance 326 may be a non-zero difference between a ring radius 316 of the ring 312 and a shaft outer radius 314 of the shaft 308. As used herein, a radius is a radial distance between the rotational axis 199 and the referenced component. The first radial distance 326 may be selected according to a desired flexibility of the interface 340 between the rotor shaft 308 and the rotor core 304. For example, a relatively short first radial distance 326 may increase flexibility of the interface compared to a relatively long first radial distance 326. Similarly, size of the cavities 302 may be related to flexibility of the interface 340. For example, increasing the cross sectional area of the cavities 302 may increase flexibility of the flexible interface 340 while decreasing the cross sectional area may decrease flexibility. Increased flexibility of the flexible interface 340 may allow greater interference between the shaft 308 and the rotor core 304. However, increasing flexibility of the interface 340 excessively, for example by increasing size of the cavities 302 and/or elasticity of the elastic material, may degrade structural integrity of the rotor core 304. Thus, the cavities 302 may be sized and positioned within ranges for optimal flexibility according to an application (e.g., size, mass, intended rotational speed maximum, etc.). For example, the length 322 may be ten to twenty times greater than the width 328. Additionally or alternatively, the first radial distance 326 may be two to five times greater than the width 328. Additionally or alternatively, the first radial distance 326 may be less than (e.g., one tenth to two thirds of) the thickness 324 of the rotor shaft 308. Additionally or alternatively, the length 322 multiplied by the number of cavities 302 (e.g., six as shown in FIG. 3) may be one fourth to three fourths of the circumference of the ring 312. Other relative dimensions are also possible without departing from the scope of the present disclosure.

The cavities 302 may be a second radial distance 330 from an outer surface 332 of the rotor core 304. The outer surface 332 may be a cylindrical surface comprised of axially aligned outer edges of rotor lamination layers. The second radial distance 330 may be larger (e.g., more than ten times longer) than the first radial distance 326. The pole section 310 may be interposed between the outer surface 332 and the ring 312.

The cavities 302 may be a third radial distance 336 from the pole section 310. The third radial distance 336 may be a non-zero difference between the second radial distance 330 and a pole section radius 318 of an approximate inner boundary 334 showing approximately where the pole section 310 ends. For example, the electromagnetic elements 306 may be radially outside, but not radially inside, of the approximate inner boundary 334. The approximate inner boundary 334 may inscribe the radially innermost points of the electromagnetic elements 306. The third radial distance 336 may be three to ten times longer than the first radial distance 326. Additionally or alternatively, the third radial distance 336 may be one fourth to three fourths of the second radial distance 330.

Focusing on FIG. 4, a shape of the cavities 302 may include rounded end portions 402 on both ends of a main portion 404. The main portion 404 may be elongated with the width 328 and the rounded end portions 402 may be ovular, circular, or other bulbous shape that is wider than the width 328 of the main portion 404. The main portion 404 may bend (e.g., curve) to follow the circular arc or the ring 312, in at least some examples. For example, a radius of curvature of the circular arc may be the ring radius 316. The main portion 404 may be a majority of the length 322. Inclusion of the rounded end portions 402 rather than rectangular or other polygonal shaped ends may prevent stress concentration at corners, allowing for more even stress distribution within the cavities 302. In other examples, the main portion 404 may not be thinner than the rounded end portions 402. In such an example, the cavities 302 may be shaped as an oval or circle that has been elongated and curved, with rounded ends continuous with the main portion 404 rather than bulbous shapes on both ends.

Turning to FIGS. 5 and 6, a second example of a rotor assembly 500 in accordance with the present disclosure is shown in an axial view looking down the rotational axis 199. The rotor assembly 500 is an example of the rotor assembly 105 of FIGS. 1 and 2. As such, the rotor assembly 300 includes a press-fit rotor core 504 (e.g., a second example of the rotor core 104) positioned on the rotor shaft 308 of rotor assembly 300 in FIGS. 3 and 4 with a flexible interface 540 (e.g., a second example of the interface 208 of FIG. 2) therebetween. A portion 550 of FIG. 5 is shown enlarged in FIG. 6.

The rotor core 504 includes the pole section 310 and the electromagnetic elements 306 in the pole section 310 as described above with regards to the rotor assembly 300 of FIGS. 3 and 4. The rotor core 504 also includes the cavities 302 arranged in the first ring 312 as described above, the cavities 302 increasing flexibility of the flexible interface 540 between the rotor shaft 308 and the rotor core 504 to allow greater interference and therefore a stronger press-fit coupling therebetween.

The rotor core 504 further includes a second ring 512 of the cavities 302, positioned radially further outward than and concentric with the first ring 312. Inclusion of additional cavities 302 may further increase flexibility of the interface 540, compared to the interface 340 of the rotor assembly 300. There may be more cavities 302 in the second ring 512 than the first ring 312. For example, there may be twice as many cavities 302 in the second ring 512 compared to the first ring 312. In other examples, there may be fewer cavities in the radially outer ring (e.g., second ring 512) than the radially inner ring (e.g., first ring 312). The cavities 302 may be dashed, or discontinuous, along the ring 512 with spaces between the cavities 302. The ring 512 of cavities 302 may be concentric with the first ring 312 and the rotor shaft 308 about the rotational axis 199. The cavities 302 in the ring 512 may be shaped and sized approximately the same to one another. As described above, the cavities 302 may bend (e.g., curve, arc, etc.) to follow a partial circular path around the rotor shaft 308. The cavities 302 in the ring 512 may each have a length 522 (e.g., arc length) and a width 528 (e.g., radial dimension), where the length 522 is larger than the width 528 such that the cavities 302 are elongated in the angular directions. The length 522 may be greater than, approximately equal to, or less than the length 322. Like the cavities 302 of the first ring 312, the cavities 302 of the second ring 512 may each be adjacent to two other cavities 302 in the same ring. Due to the arc-shape of the cavities 302, if the length 522 was extended sufficiently to overlap cavities 302 in the ring 512, a continuous circular cavity would form. Likewise, if the length 322 was extended sufficiently to overlap cavities 302 in the ring 312, a continuous circular cavity would form with the ring radius 316.

Rather than a single equidistant space between adjacent cavities 302 as in the ring 312, the cavities 302 of the second ring 512 may be arranged with alternating space sizes therebetween. For example, each of the cavities 302 in the second ring 512 may be a first angular distance 520 away from one other cavity 302 in the ring 512 and a second angular distance 524 away from another of the cavities 302 in the ring 512, where the first angular distance 520 and the second angular distance 524 are not equal. In this way, the cavities 302 in the second ring 512 may be grouped in twos. In other examples, the cavities 302 may be grouped by spaces therebetween in threes or more. For example, a larger space between adjacent cavities 302 may be positioned every three cavities 302, so long as the number of cavities 302 in the ring is a multiple of three. The first angular distance 520 and the second angular distance 524 may be shorter than the angular distance 320 between adjacent cavities 302 in the first ring 312. The cavities 302 in the second ring 512 may be arranged symmetrically with respect to the rotational axis 199. In this way, the presence of the cavities 302 in the first and second rings 312, 512 may not impede rotational balance of the rotor core 304.

As described above, the cavities 302, including cavities of the first and second rings 312, 512, may be filled with an elastic material to provide flexibility to the flexible interface 540 between the rotor core 504 and the rotor shaft 308. The angular distances 520, 524 may be greater than, approximately equal to, or less than the length 522 of the cavities 302 in the ring 512, according to a desired proportion of flexible areas along the ring 512. In comparing two examples with the same number of cavities 302 in the ring 312 and the ring 512, the example with a greater distance 520 and/or distance 524 (and therefore shorter length 522) may have relatively less flexibility in the interface 540.

Alternatively, the cavities 302 in the ring 512 may not all be the same size. For example, the length 522 of some cavities 302 may be longer than others. In such an example, each set of the cavities 302 of the same size and shape may be evenly distributed with respect to the rotational axis 199. For example, longer cavities may be alternated with shorter cavities to maintain rotational balance of the rotor assembly 500.

The cavities 302 in the second ring 512 may be a first radial distance 526 from the rotor shaft 308. The first radial distance 526 may be a non-zero difference between a ring radius 516 of the ring 512 and the shaft outer radius 314. The first radial distance 526 may be greater than the first radial distance 326 such that the second ring 512 is a radially outer ring and the first ring 312 is a radially inner ring. The first radial distance 526 may be selected according to a desired flexibility of the interface 540 between the rotor shaft 308 and the rotor core 504. For example, a relatively short first radial distance 526 (that is still greater than the distance 326) may increase flexibility of the interface compared to a relatively long first radial distance 526. Thus, the cavities 302 may be sized and arranged in the ring 312 and the second ring 512 for optimal flexibility. For example, the length 522 may be ten or more times greater than the width 528. Additionally or alternatively, the first radial distance 526 may be two or more times greater than the width 528. Additionally or alternatively, the first radial distance 526 may be approximately twice the first radial distance 326. Additionally or alternatively, the first radial distance 526 may be less than or equal to the thickness 324 of the rotor shaft 308. Additionally or alternatively, the length 522 multiplied by the number of cavities 302 (e.g., twelve as shown in FIG. 5) may be more than three fourths of the circumference of the ring 312. Other relative dimensions are also possible without departing from the scope of the present disclosure.

The cavities 302 in the second ring 512 may be a second radial distance 530 from an outer surface 532 of the rotor core 304. Like the outer surface 332, the outer surface 532 may be a cylindrical surface comprised of axially aligned outer edges of rotor lamination layers. The second radial distance 530 may be shorter than the second radial distance 330 due to the second ring 512 being a radially outer ring relative to the first ring 312. The second radial distance 530 may be longer (e.g., more than four times longer) than the first radial distance 526. The pole section 310 may be interposed between the outer surface 532 and the second ring 512. The second ring 512 may be interposed between the pole section 310 and the first ring 312. The first ring 312 may be interposed between the second ring 512 and the interface 540.

The cavities 302 in the second ring 512 may be a third radial distance 536 from the pole section 310. The third radial distance 336 may be a non-zero difference between the second radial distance 330 and the pole section radius 318. The third radial distance 536 may be shorter than the third radial distance 336 due to the second ring 512 being radially further than the ring 312. The third radial distance 536 may be longer than the first radial distance 526 such that the cavities 302 are distanced further from the pole section 310 than the rotor shaft 308. Specifically, the cavities 302 may be distanced further from the electromagnetic elements 306 than the rotor shaft 308. For example, the third radial distance 536 may be at least twice as long as the first radial distance 526. Additionally or alternatively, the third radial distance 536 may be less than (e.g., one half or less) of the second radial distance 530.

The cavities 302 in the first and second rings 312, 512 may be substantially the same shape, having the main portion 404 and two rounded end portions 402. However, the cavities 302 may have different relative dimensions (e.g., lengths 322 and 522 may be unequal and/or widths 328 and 528 may be unequal), so long as the cavities 302 are arranged in the first and second rings 312, 512 in a manner where rotational balance of the rotor assembly 500 is maintained.

Turning to FIGS. 7 and 8, a third example of a rotor assembly 700 in accordance with the present disclosure is shown in an axial view looking down the rotational axis 199. The rotor assembly 700 is an example of the rotor assembly 105 of FIGS. 1 and 2. As such, the rotor assembly 700 includes a press-fit rotor core 704 (e.g., a third example of the rotor core 104) positioned on the rotor shaft 308 of rotor assembly 300 in FIGS. 3 and 4 and the rotor assembly 500 in FIGS. 5 and 6. A flexible interface 740 (e.g., a third example of the interface 208 of FIG. 2) is formed between the rotor core 704 and the rotor shaft 308. A portion 750 of FIG. 7 is shown enlarged in FIG. 8.

The rotor core 704 includes a pole section 710 encompassing electromagnetic elements 702, similar to the pole section 310 of FIGS. 3-6. The pole section 710 may be a region of the rotor core 704 radially further outward than an approximate inner boundary 712 that inscribes magnets or windings arranged in the pole section 710 in any arrangement conducive to the application. The magnets or windings may not be present in any location radially inward of the inner boundary 712. The pole section 710 may include a different arrangement of magnets or windings than the pole section 310 of the rotor assembly 300 of FIGS. 3 and 4 and the rotor assembly 500 of FIGS. 5 and 6. Other configurations of the magnets or windings within the pole section are possible without departing from the scope of the present disclosure.

The rotor core 704 also includes the cavities 302, the cavities 302 increasing flexibility of the flexible interface 740 between the rotor shaft 308 and the rotor core 704 to allow greater interference and therefore a stronger press-fit coupling therebetween. However, the cavities 302 are arranged differently in the rotor core 704 than the rotor core 304 of FIGS. 3 and 4 and the rotor core 504 of FIGS. 5 and 6.

For example, the cavities 302 may be arranged in a first ring 706 and a second ring 708. The rings 706, 708 of the cavities 302 may be concentric with each other and with the rotor shaft 308 about the rotational axis 199. The first ring 706 may have a first ring radius 730 that is smaller than a second ring radius 732 of the second ring 708 such that the first ring 706 is a radially inner ring and the second ring 708 is a radially outer ring. As described above, the cavities 302 may bend (e.g., curve, arc, etc.) to follow a circular path around the rotor shaft 308, and further may be positioned such that the circular path continues within the respective rings 706, 708. There may be two or more of the cavities 302 per ring. The first and second radii 730, 732 may be less than a radius of the approximate inner boundary 718.

The cavities 302 in the first ring 706 may each have a first length 722 (e.g., arc length) and a first width 728 (e.g., radial dimension), where the first length 722 is larger than the first width 728 such that the cavities 302 are elongated in the angular directions. The cavities 302 in the first ring 706 may be uniformly distributed with an equidistant spacing of angular distance 720 between adjacent cavities 302 in the first ring 706.

The cavities 302 in the second ring 708 may each have a second length 714 (e.g., arc length) and a second width 716 (e.g., radial dimension), where the second length 714 is larger than the second width 716 such that the cavities 302 are elongated in the angular directions. The cavities 302 in the second ring 708 may be uniformly distributed with an equidistant spacing of angular distance 724 between adjacent cavities 302 in the second ring 708.

In at least some examples, the cavities 302 may all have the same shape and size. For example, the first length 722 and the first width 728 may be approximately the same as the second length 714 and the second width 716, respectively. Thus, the first angular distance 720 may be shorter than the second angular distance 724. Alternatively, the first angular distance 720 may be approximately the same as the second angular distance 724. Thus, the first length 722 may be shorter than the second length 714.

As described above, the cavities 302 in the first and second rings 706, 708 may be spaced away from and interposed between the pole section 710 and the rotor shaft 308. Distances between the cavities 302, and the rotor shaft 308 may be adjusted to reach a desired flexibility of the interface 740.

Focusing on FIG. 8, the shape of the cavities 302 may include the rounded end portions 402 on both ends of the main portion 404, as described above. The main portion 404 may be elongated with the width 716 or the width 728 (which may be greater than, less than, or equal to the width 716) according to the corresponding ring comprising the cavity 302. The rounded end portions 402 may be ovular, circular, or other bulbous shape that is wider than the widths 716, 728 of the main portions 404. For example, the rounded end portions 402 may be between twice and five times the thickness of the main portion 404.

The configurations of the cavities 302 provided in FIGS. 3-8 are non-limiting, and other examples are possible without departing from the scope of the present disclosure. For example, the cavities may be arranged in three or more rings, in other examples. Further rings may provide additional adjustability of the flexibility of the interface between the rotor core and the rotor shaft. Additionally or alternatively, each ring may comprise more or fewer rings than shown in the exemplary configurations described herein. Additionally or alternatively, there may be longer or shorter distances between adjacent cavities within a corresponding ring than in the examples provided herein.

In addition to arrangement of dashed circumferential cavities, contact conditions at the press-fit interface between a rotor core and a rotor shaft of the present disclosure may be adjusted to reach a desired flexibility of the interface therebetween according to an application of the rotor assembly comprising the rotor core and the rotor shaft. Turning to FIGS. 9, 10, and 11, the rotor assembly 500 is shown in a first example 900, a second example 1000, and a third example 1100, respectively, with different contact conditions in each example. For example, the contact conditions may be adjusted by altering geometry of the surfaces of the rotor shaft 308 and/or the rotor core 504 that meet at the interface 540. In this way, there may be partial or full circumferential contact between the rotor shaft 308 and the rotor core 504.

In the first example 900, there is continuous flexible contact at the interface 540 between the rotor core 504 and the rotor shaft 308, as indicated by a shaded ring comprising a single continuous contact surface 902 along the entire interface 540. Thus, in the first example 900, the interface 540 may be described as a continuous flexible interface. Under continuous flexible contact conditions, the entire circumference of the outer surface of the shaft 308 is in face-sharing contact with the entire circumference of the inner surface of the rotor core 504 at the interface 540. Flexibility is provided by the cavities 302 being filled with an elastic material, as described above. In this way, contact pressure due to the press-fit connection between the rotor core 504 and the rotor shaft 308 may be evenly distributed along the entire continuous flexible interface.

In the second example 1000, there is discontinuous flexible contact at the interface 540 between the rotor core 504 and the rotor shaft 308, as indicated by a discontinuous ring comprising a plurality of flexible contact points 1002 along the interface 540. Thus, in the second example 1000, the interface 540 may be described as a discontinuous flexible interface. Areas between the adjacent flexible contact points 1002 may not be in face-sharing contact. The plurality of flexible contact points 1002 may be equidistantly arranged along the interface 540. Additionally or alternatively, the plurality of flexible contact points 1002 may be approximately the same length as each other. Under discontinuous flexible contact conditions, parts of the circumference of the outer surface of the rotor shaft 308 are in face-sharing contact with parts of the circumference of the inner surface of the rotor core 504 at the plurality of flexible contact points 1002. In this way, contact pressure may be concentrated in the flexible contact points 1002 of the discontinuous flexible interface, rather than evenly distributed along the entire interface 540.

In the third example 1100, there is alternating discontinuous flexible and rigid contact at the interface 540 between the rotor core 504 and the rotor shaft 308, as indicated by a discontinuous ring comprising the plurality of flexible contact points 1002 and a plurality of rigid contact points 1102 alternating along the interface 540. The plurality of rigid contact points 1102 may be further from the cavities 302 than the plurality of flexible contact points 1002, and therefore may be more rigid. For example, the plurality of rigid contact points 1102 may be radially aligned with gaps in a radially inner ring (or a single ring), and the plurality of flexible contact points 1002 may be radially aligned with the cavities 302 of the inner ring (or the single ring). Thus, in the third example 1100, the interface 540 may be described as an alternating discontinuous flexible and rigid interface. Under alternating discontinuous flexible and rigid contact conditions, parts of the circumference of the outer surface of the rotor shaft 308 are in face-sharing contact with parts of the circumference of the inner surface of the rotor core 504 at the plurality of flexible contact points 1002 and the plurality of rigid contact points 1102. In this way, contact pressure may be concentrated in the flexible contact points 1002 and the rigid contact points 1102 of the alternating discontinuous flexible and rigid interface, rather than evenly distributed along the entire interface 540.

The rotor core 504 is used as an example for demonstrating different contact conditions in FIGS. 9-11, however any other rotor core in accordance with the present disclosure (e.g., rotor core 104 of FIGS. 1 and 2, rotor core 304 of FIGS. 3 and 4, rotor core 704 of FIGS. 7 and 8) may have any of the contact conditions described herein (e.g., continuous flexible, discontinuous flexible, or alternating discontinuous flexible and rigid). In this way, rotor assemblies in accordance with the present disclosure may be adaptable to various operating conditions (e.g., rotational speed range) within a system (e.g., a vehicle such as an electric or hybrid vehicle, or a stationary system) by selecting cavity arrangement and contact conditions accordingly.

Turning to FIG. 12, a method 1200 for forming a rotor assembly in accordance with the present disclosure (e.g., rotor assembly 300 of FIGS. 3 and 4, rotor assembly 500 of FIGS. 5 and 6, rotor assembly 700 of FIGS. 7 and 8, first example 900 of FIG. 9, second example 1000 of FIG. 10, third example 1100 of FIG. 11) is shown as a flowchart. The method 1200 may be executed at least in part by machinery of an automated assembly line, for example.

The method 1200 begins at 1202, wherein dashed circumferential slots are stamped or cut into rotor laminations. For example, a metal blank may be stamped or cut (e.g., laser cut or EDM cut) to form an annular shape with the dashed circumferential slots. In this way, cutting or stamping the slots may be performed at the same time as the lamination shape is formed.

The method 1200 proceeds to 1204, wherein the rotor laminations are stacked with the dashed circumferential slots axially aligned to form a rotor core with dashed circumferential cavities. The rotor laminations may be stacked in face-sharing contact and aligned along a central axis to form a cylindrical rotor core with a cylindrical opening therein configured to receive a rotor shaft. Additionally, the rotor laminations may be oriented such that the dashed circumferential slots axially align parallel with the cylindrical opening to form dashed circumferential cavities that extend along the entire length of the rotor core.

The method 1200 proceeds to 1206, wherein the dashed circumferential cavities are filled with an elastic material. In this way, the elastic material may be embedded within the rotor core. In some examples, the elastic material may be thermally conductive. In such examples, the elastic material may be a single material that is both elastic and thermally conductive, or the elastic material may be a blend of two or more materials, at least one providing elasticity and at least one providing thermal conductivity.

The method 1200 proceeds to 1208, wherein the rotor core is press-fitted onto a rotor shaft. For example, the rotor core may be inserted into the cylindrical opening in the rotor core with interference therebetween. Due to the elastic material filled dashed circumferential cavities, the interface between the rotor core and the rotor shaft may be flexible, allowing for greater interference without increasing stress at a pole section of the rotor core.

The method 1200 ends. After completing the method 1200, a rotor assembly is formed with a flexible shaft interface such that stress is concentrated in the flexible areas (e.g., filled cavities) and reduced elsewhere (e.g., pole section). In this way, the rotor assembly may have adequate contact pressure to maintain mechanical coupling between the rotor core and the rotor shaft with reduced consequences of high interference, such as buckling of the rotor core leading to increased NVH and lower efficiency of the electric motor comprising the rotor assembly.

Turning to FIG. 13, a process 1300 is shown schematically for forming a rotor core in accordance with the present disclosure (e.g., rotor core 104 of FIGS. 1 and 2, rotor core 304 of FIGS. 3 and 4, rotor core 504 of FIGS. 5 and 6, or rotor core 704 of FIGS. 7 and 8), such as by completing steps of the method 1200 of FIG. 12.

A rotor lamination 1302 of a rotor core in accordance with the present disclosure may be formed by stamping and/or cutting a metal blank to create an annular shape having an outer edge 1310, an inner edge 1308 defining a central opening 1314, and dashed circumferential slots 1312 therebetween. For example, the rotor lamination 1302 may be formed by completing step 1202 of the method 1200 in FIG. 12. The dashed circumferential slots 1312 may be arranged in one or more rings that are concentric with each other and with the opening 1314. The arrangement of the dashed circumferential slots 1312 may determine the arrangement of dashed circumferential cavities 1320 in the rotor core 1306 formed from the rotor laminations 1302 later in the process. There may be additional features in the rotor lamination 1302, such as openings adapted to receive magnets (e.g., electromagnetic elements 306 of FIGS. 3-6) or windings, which are not shown in FIG. 13 for clarity.

A plurality of the rotor laminations 1302 may be stacked to form an unfilled rotor core 1304 centered on the rotational axis 199. For example, the unfilled rotor core 1304 may be the result of completing step 1204 in the method 1200 of FIG. 12. The rotor laminations 1302 may be axially aligned such that the inner edges 1308 form a cylindrical through-hole 1318 extending through the unfilled rotor core 1304, the outer edges 1310 form an outer cylindrical surface 1316, and the dashed circumferential slots 1312 form dashed circumferential cavities 1320 extending parallel to the rotational axis 199 through the rotor core 1304. The dashed circumferential cavities 1320 may be hollow spaces prior to filling.

The dashed circumferential cavities 1320 may be filled with an elastic material (as indicated by shading) to form rotor core 1306 from the unfilled rotor core 1304. For example, the rotor core 1306 may be formed form the unfilled rotor core 1304 by completing step 1206 of method 1200 in FIG. 12. The elastic material may also be thermally conductive, in at least some examples.

The rotor core 1306 may be press-fitted onto a rotor shaft (e.g., rotor shaft 108 of FIGS. 1 and 2, rotor shaft 308 of FIGS. 3-11) by inserting the rotor shaft into the cylindrical through-hole 1318 (e.g., by completing step 1208 of the method 1200 of FIG. 12) to form a rotor assembly in accordance with the present disclosure (e.g., rotor assembly 300 of FIGS. 3 and 4, rotor assembly 500 of FIGS. 5, 6, and 9-11, or rotor assembly 700 of FIGS. 7 and 8). The elastic-filled dashed circumferential cavities 1320 may provide flexibility to an interface between the rotor shaft and the rotor core 1306 and concentrate stress at the elastic-filled dashed circumferential cavities 1320. In this way, greater interference may be imposed on the rotor core and the rotor shaft to increase strength of the mechanical and rotational coupling therebetween with reduced negative consequence to the electromagnetic behavior of the rotor core, specifically the pole section where conductive windings or magnets are positioned.

The technical effect of the rotor assembly of the present disclosure comprising a press-fit rotor core positioned on a rotor shaft is to embed elastic material into the rotor core (e.g., by filling cavities with the elastic material) in close proximity to the rotor shaft (e.g., relative to the outer surface of the rotor core) to increase compliance and reduce stresses generated by high interference fit. The flexible nature of the elastic material may allow for high deflections, while localizing the stress field generated by the high interference fit within the elastic material. Thus, the embedded elastic material may allow sufficient contact pressure to maintain mechanical and rotational coupling between the rotor core and the rotor shaft, and transfer torque therebetween. Additionally, stress may be reduced in areas located further from the rotor shaft than the elastic material, including the pole section. Further, a global reduction (e.g., throughout the entire rotor assembly) in stress induced by the press-fit may result from including the elastic-filled cavities. By reducing stress, particularly at the pole section, likelihood of buckling of the rotor core may be decreased.

The disclosure also provides support for a rotor assembly, comprising: a rotor shaft, and a press-fit rotor core positioned on the rotor shaft, the rotor core including circumferential cavities positioned proximate to the rotor shaft, where the cavities are arranged in one or more rings concentric with each other and with the rotor shaft, and the cavities are filled with an elastic material. In a first example of the system, the cavities are spaced away from a pole section of the rotor core. In a second example of the system, optionally including the first example, a first radial distance between the cavities and the rotor shaft is less than a second radial distance between the cavities and an outer surface of the rotor core. In a third example of the system, optionally including one or both of the first and second examples, a third radial distance between the cavities and a pole section of the rotor core is greater than the first radial distance and less than the second radial distance. In a fourth example of the system, optionally including one or more or each of the first through third examples, the cavities are each elongated along a circular arc and have rounded end portions. In a fifth example of the system, optionally including one or more or each of the first through fourth examples, a radius of curvature of the circular arc is a ring radius of the ring comprising the cavity. In a sixth example of the system, optionally including one or more or each of the first through fifth examples, the elastic material is thermally conductive.

The disclosure also provides support for an electric motor, comprising: a rotor assembly including a rotor shaft and a press-fit rotor core on the rotor shaft with a flexible interface therebetween, where the rotor core comprises dashed circumferential cavities surrounding the flexible interface and filled with an elastic material, and a stator that electromagnetically interacts with the rotor core to drive rotation of the rotor assembly. In a first example of the system, the cavities are arranged in one or more rings concentric with each other and with the rotor shaft. In a second example of the system, optionally including the first example, the cavities are distanced further from electromagnetic elements arranged in a pole section of the rotor core than the rotor shaft. In a third example of the system, optionally including one or both of the first and second examples, the flexible interface is a continuous flexible interface. In a fourth example of the system, optionally including one or more or each of the first through third examples, the flexible interface is a discontinuous flexible interface comprising a plurality of flexible contact points. In a fifth example of the system, optionally including one or more or each of the first through fourth examples, the flexible interface is an alternating discontinuous flexible and rigid interface comprising a plurality of rigid contact points and a plurality of flexible contact points. In a sixth example of the system, optionally including one or more or each of the first through fifth examples, the elastic material is thermally conductive.

The disclosure also provides support for a vehicle, comprising: an energy storage device, an electric motor electrically coupled to the energy storage device, the electric motor including a stator that electromagnetically interacts with a rotor assembly to drive rotation thereof, where the rotor assembly comprises a press-fit rotor core positioned on a rotor shaft, and the rotor core includes dashed circumferential cavities filled with an elastic material and interposed between a pole section of the rotor core and an interface between the rotor core and the rotor shaft, and a controller that includes memory with instructions stored therein that when executed cause the controller to adjust a rotational speed of the rotor assembly. In a first example of the system, the dashed circumferential cavities are arranged in one or more rings concentric with each other and with the rotor shaft. In a second example of the system, optionally including the first example, the dashed circumferential cavities are radially closer to the rotor shaft than to the pole section. In a third example of the system, optionally including one or both of the first and second examples, each of the dashed circumferential cavities includes rounded end portions on both ends of a main portion. In a fourth example of the system, optionally including one or more or each of the first through third examples, the main portion is curved to follow a circular arc. In a fifth example of the system, optionally including one or more or each of the first through fourth examples, the vehicle further comprises a thermal management system that flows coolant fluid through a hollow center of the rotor shaft and the elastic material is thermally conductive such that heat is transferred between the pole section and the rotor shaft via the elastic material.

FIGS. 1, 2, and 13 show schematics of an example configuration with relative positioning of the various components. FIGS. 3-11 are shown approximately to scale; though other relative dimensions may be used. As used herein, the terms “approximately” is construed to mean plus or minus five percent of the range unless otherwise specified.

If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. Moreover, the components may be described as they relate to reference axes included in the drawings.

Features described as axial may be approximately parallel with an axis referenced unless otherwise specified. Features described as counter-axial may be approximately perpendicular to the axis referenced unless otherwise specified. Features described as radial may circumferentially surround or extend outward from an axis, such as the axis referenced, or a component or feature described prior as being radial to a referenced axis, unless otherwise specified.

Features described as longitudinal may be approximately parallel with an axis that is longitudinal. A lateral axis may be normal to a longitudinal axis and a vertical axis. Features described as lateral may be approximately parallel with the lateral axis. A vertical axis may be normal to a lateral axis and a longitudinal axis. Features described as vertical may be approximately parallel with a vertical axis.

It will be appreciated that the configurations and routines disclosed herein are exemplary in nature, and that these specific embodiments are not to be considered in a limiting sense, because numerous variations are possible. Moreover, unless explicitly stated to the contrary, the terms “first,” “second,” “third,” and the like are not intended to denote any order, position, quantity, or importance, but rather are used merely as labels to distinguish one element from another. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A rotor assembly, comprising:
a rotor shaft; and
a press-fit rotor core positioned on the rotor shaft, the rotor core including circumferential cavities positioned proximate to the rotor shaft, where the cavities are arranged in one or more rings concentric with each other and with the rotor shaft.

2. The rotor assembly of claim 1, wherein the cavities are spaced away from a pole section of the rotor core.

3. The rotor assembly of claim 1, wherein a first radial distance between the cavities and the rotor shaft is less than a second radial distance between the cavities and an outer surface of the rotor core.

4. The rotor assembly of claim 3, wherein a third radial distance between the cavities and a pole section of the rotor core is greater than the first radial distance and less than the second radial distance.

5. The rotor assembly of claim 1, wherein the cavities are each elongated along a circular arc and have rounded end portions.

6. The rotor assembly of claim 5, wherein a radius of curvature of the circular arc is a ring radius of a corresponding ring of the one or more rings.

7. The rotor assembly of claim 1, wherein the cavities are filled with an elastic material, and the elastic material is thermally conductive.

8. An electric motor, comprising:
a rotor assembly including a rotor shaft and a press-fit rotor core positioned on the rotor shaft with a flexible interface therebetween, where the rotor core comprises dashed circumferential cavities surrounding the flexible interface and filled with an elastic material; and
a stator that electromagnetically interacts with the rotor core to drive rotation of the rotor assembly.

9. The electric motor of claim 8, wherein the cavities are arranged in one or more rings concentric with each other and with the rotor shaft.

10. The electric motor of claim 8, wherein the cavities are distanced further from electromagnetic elements arranged in a pole section of the rotor core than the rotor shaft.

11. The electric motor of claim 8, wherein the flexible interface is a continuous flexible interface.

12. The electric motor of claim 8, wherein the flexible interface is a discontinuous flexible interface comprising a plurality of flexible contact points.

13. The electric motor of claim 8, wherein the flexible interface is an alternating discontinuous flexible and rigid interface comprising a plurality of rigid contact points and a plurality of flexible contact points.

14. The electric motor of claim 8, wherein the elastic material is thermally conductive.

15. A vehicle, comprising:
an energy storage device;
an electric motor electrically coupled to the energy storage device, the electric motor including a stator that electromagnetically interacts with a rotor assembly to drive rotation thereof, where the rotor assembly comprises a press-fit rotor core positioned on a rotor shaft, and the rotor core includes dashed circumferential cavities filled with an elastic material and interposed between a pole section of the rotor core and an interface between the rotor core and the rotor shaft; and
a controller that includes memory with instructions stored therein that when executed cause the controller to adjust a rotational speed of the rotor assembly.

16. The vehicle of claim 15, wherein the dashed circumferential cavities are arranged in one or more rings concentric with each other and with the rotor shaft.

17. The vehicle of claim 15, wherein the dashed circumferential cavities are radially closer to the rotor shaft than to the pole section.

18. The vehicle of claim 15, wherein each of the dashed circumferential cavities includes rounded end portions on both ends of a main portion.

19. The vehicle of claim 18, wherein the main portion is curved to follow a circular arc.

20. The vehicle of claim 15, wherein the vehicle further comprises a thermal management system that flows coolant fluid through a hollow center of the rotor shaft and the elastic material is thermally conductive such that heat is transferred between the pole section and the rotor shaft via the elastic material.
